(19) United States
(12) Patent Application Publication
(10) Pub. No.: US 2007/0131179 A1
(43) Pub. Date: Jun. 14, 2007

(54) Elliptical rotary motor with internal combustion

(76) Inventor: Vojislav Jurisic, Batanjnica (YU)

Correspondence Address: JOHN RUSSELL UREN, 1337 Gulf Road, PO BOX 1304, POINT ROBERTS, WA, 98281-1304, US

(21) Appl. No.: 10/598,099

(22) PCT Filed: Feb. 10, 2005
(86) PCT No.: PCT/IB05/01018

§ 371 Date: Aug. 17, 2006

(30) Foreign Application Priority Data
Feb. 18, 2004 (YU) P-143/04

(51) Int. Cl. F02B 53/00

(52) U.S. Cl. 123/18 R

(57) ABSTRACT

A method and apparatus consisting of a stator (1) within which rotates rotor (2) together with work cylinder (3) and piston (6) which is via rod (7) and larger pin (9) connected with rocker (8) which via smaller pin (10) transfers rotary moment to rotor (2), i.e. to output shafts (17) and (20). At the same time rod (7), via larger pin (9) by its own motion moves satellite gears (12), which, off-center mounted bearings (13) and symmetrically geared to off-center mounted inner-tooth gears (11), define position of working cylinder (3) relative to two ODC and two IDC.

### CROSS-REFERENCE TO RELATED APPLICATIONS

This application claims benefit of Serbian patent application serial number P-143/04, filed Feb. 18, 2004, which is herein incorporated by reference.

### BACKGROUND OF THE INVENTION

### Field of the Invention

Invention is from the field of piston internal combustion engines, or closer-engines with rotary pistons. By International Patent Classification, (ICP) it belongs to group F 02B 53/00.

### SUMMARY OF THE INVENTION

The present invention solves the problem of efficient removal of residual products of combustion from working cylinder of the motor and efficient charge of the cylinder with fresh intake mixture, increases degree of compression and expansion of the cycle, enhances combustion of mixture and improves quality of exhaust gasses, reduces fuel consumption, accomplishes more stable operation of motor and attains higher degree of thermodynamic efficiency coefficient.

The only similar example known to the inventor of this solution is inventors own patent named segmented (internal combustion) motor published May 20, 1996 under number 47919. First shortcoming of that solution (as described in solution to technical problem of named patent 47919), is that inner diameter of motor housing and diameter of inner-tooth gear should be same. Second shortcoming of above mentioned solution (as stated in description of solution of technical problem and abstract of patent 47919) is that small gear transfers rotary moment to output shafts. Third shortcoming of that solution is insufficiently effective removal of residue of combustion and (because of residue of combustion) ineffective charge of cylinder with fresh intake mixture, or with air in case of diesel version of motor.

Core of this invention is (relative to patent 47919 named Segmented internal combustion motor):
efficient elimination of all residual products of combustion and corresponding to that achievement of better charge of cylinder with fresh intake mixture, or air in case of diesel motor.
increased degree of compression (expansion) of work cycle.
rotary moment is transferred directly from rotor (and not by gears) to output shafts.

Innovation of the invention is introduction of vertical and horizontal off-centering of e/v and e/h, in effect shifting of axis of symmetry of inner-tooth gear relative to rotation axis.

Innovation is rocker which, weather “pushing” or “pulling” rotor, transfers rotary moment to output shafts and defines size of angle of duration of certain strokes of cycle.

Innovation is that output shafts are integral parts of rotor.

Innovation is that relation between diameter of big (inner-tooth gear) and diameter of small (satellite) gear is always 1:2, rather, gear ratio is i=2.

Innovation of invention is that diameter of inner-tooth gear does not have to be equal to inner diameter of housing of motor.

Innovation is that, in relation to rotation axis off-center placed needle bearings serve as carriers of satellite gear.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front view cross section of elliptical-rotary motor.

FIG. 2 is a side view cross section of elliptical-rotary motor.

FIG. 3 is a principal schematic of action within elliptical-rotary motor.

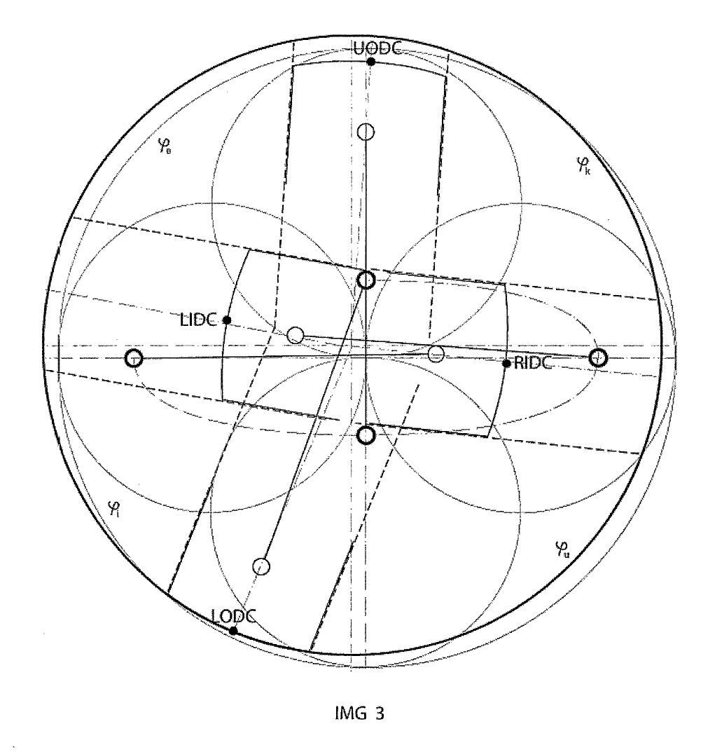

FIG. 4 shows change of displacement volume as a function of change of angle of rotation of rotor with elliptic-rotary motor (solid line) and with Segmented motor (dotted line), where Vo is starting displacement, Vg is working displacement and Vu is total displacement of working cylinder, and φ is angle of rotation of rotor.

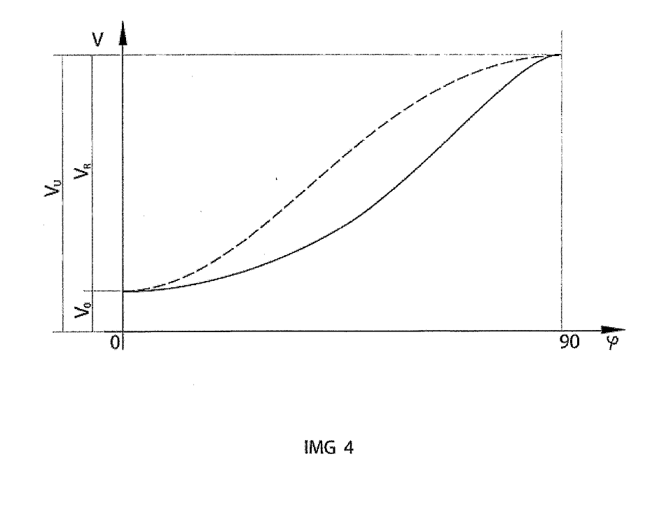

FIG. 5 shows change of arm of rotation force as a function of change of angle of rotation of rotor with elliptical-rotary motor (solid line) and with Segmented motor (dotted line), where “L” is length of arm of rotation force and φ is angle of rotation of rotor.

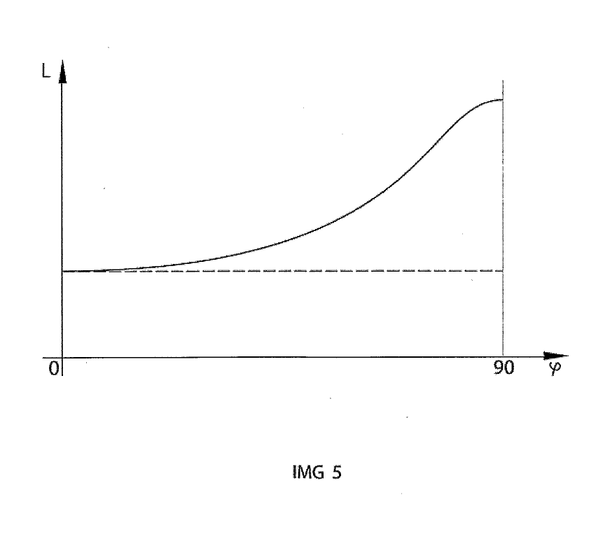

FIG. 6 shows change of rotary moments as a function of change of angle of rotation of rotor with elliptical-rotary motor (solid line) and with Segmented Motor (dotted line), where “M” is rotary moment and φ is angle of rotation of rotor.

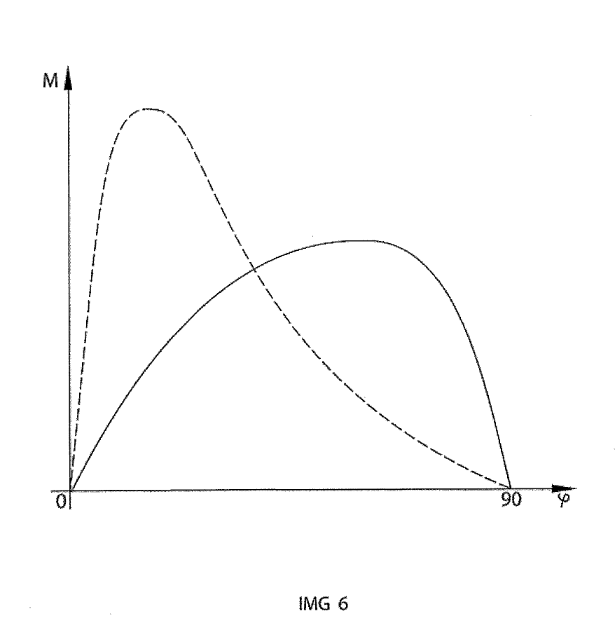

### DETAILED DESCRIPTION

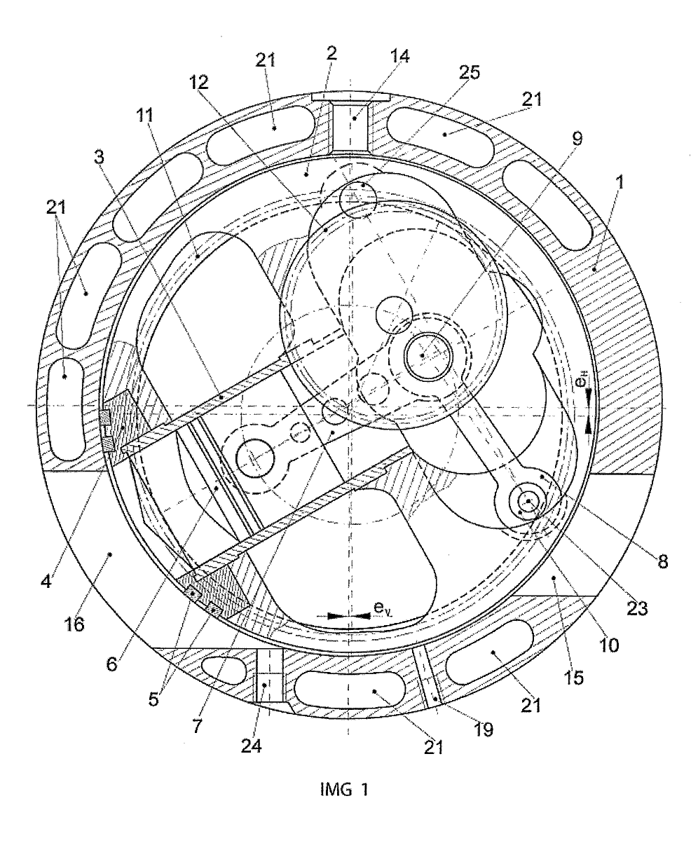

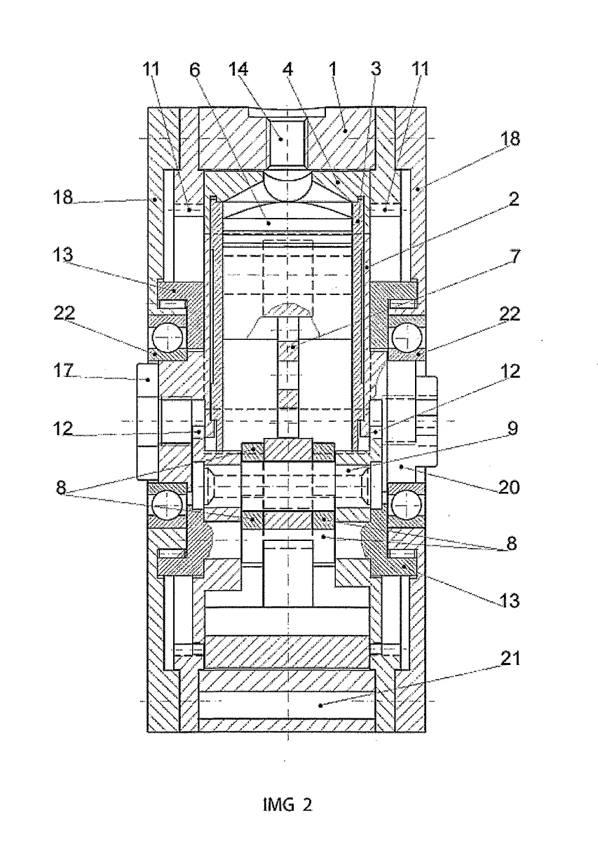

The present invention FIGS. 1 and 2 show that within stator 1 of the motor rotates rotor 2 within which is contained working cylinder 3, and within that cylinder 3 is piston 6. Under the action of force which is created by combustion of fuel piston 6, which is by way of rod 7 connected to larger pin 9, moves towards left inner dead center (IDC).

Larger pin 9 is connected to rocker 8 which is by way of smaller pin 10 connected to rotor 2 and which transfers rotary moment to rotor 2. FIG. 1 shows rotor 2 that rotates counterclockwise and, when in that position where smaller pin 10 is in opening 23, rocker 8 “pulls” rotor 2. When smaller pin 10 moves to opening 25, rocker 8 then shifts its position and it “pushes” rotor 2. Larger pin 9, due to motion of rod 7, also moves satellite gears 12 which carry off-center mounted (relative to rotor axis) roller-pin bearings 13, and which are geared to inner-tooth gear 11.

Geared pairs 11 and 12 with ratio 1:2 ( i=2) strictly define position of piston 6 relative to two outer dead centers (lower and upper ODC) and two inner dead centers (left and right IDC), and due to above mentioned transfer ratio create elliptical trajectory of a point of action of rotary force.

Rotary moment is, from rotor 2, via shafts 17 and 20, which are integral parts of rotor 2, and which rest on roller bearings 22, hence transferred to outside of motor.

By shifting horizontal axis of gear 11, by the amount of off-centering e/h-or namely by half of height between piston 6 (when piston 6 is in upper ODC relative to cylinder 3 in stage of starting displacement), the following is accomplished: at the end of exhaust cycle in lower ODC piston 6 physically completely expels residue of combustion from working cylinder 3, i.e. squeezes out residual gasses that have not evacuated working cylinder 3 thru exhaust port 16. In further rotation of rotor 2 and motion of piston 6 towards right IDC sub-pressure(almost vacuum) is created, causing intensive intake of working mixture into cylinder 3 thru the intake port 15.

Selection of position of ports 23 or 25 in rotor 2 and length of rocker 8, as well as selection of appropriate off-centers e/h and e/v accomplishes desired angles of individual strokes of work cycle. That way it is possible to select optimal angle of duration of expansion stroke with, at the same time, lesser angle of duration of exhaust and compression stroke, but larger angle of duration of intake stroke.

Seal between rotor 2 and stator 1 is done by seals 5 within the head of work cylinder 4, and cooling of motor is done by liquid coolant thru openings 21. On the stator 1 furthermore are openings for regulating vacuum 19 and opening 2 for flushing and cooling 24 of forehead (top) of piston 6. Elliptical-rotary motor is on lateral sides closed by deck-lids 18 which at the same time serve as carriers of roller bearings 22 and needle bearings 13.

When elliptical-rotary motor is done like four stroke Otto motor, then previously compressed fresh mixture is ignited by a spark from sparkplug located in position 14, and when elliptical-rotary motor is done like diesel motor, then fuel is injected into previously compressed air also from position 14.

While the foregoing is directed to embodiments of the present invention, other and further embodiments of the invention may be devised without departing from the basic scope thereof, and the scope thereof is determined by the claims that follow.

1. Elliptical-rotary motor with internal combustion, indicated so, consists of stator (1) within which rotates rotor (2) together with work cylinder (3) and piston (6) which is by rod (7) via rocker (8) connected to rotor (2).

2. Elliptical-rotary motor with internal combustion as per claim 1, indicated so, that rocker (8) is, via larger pin (9) connected with rod (7), and via smaller pin (10) which is placed in opening (23) is connected with rotor (2).

3. Elliptical-rotary motor with internal combustion as per claim 2, indicated so, that rocker (8) is, via larger pin (9) connected with rod (7) and via smaller pin (10) which is placed in opening (25) is connected with rotor (2).

4. Elliptical-rotary motor with internal combustion, as per claim 1, indicated so, that satellite gears (12) are via larger pin (9) symmetrically geared to off-center mounted inner-tooth gear (11) in the ratio i=2.

5. Elliptical-rotary motor with internal combustion as per claim 1, indicated so, that inner-tooth gears (11) are of off-center mounted relative to rotation axis and placed between stator (1) and deck-lids (18).

6. Elliptical-rotary motor with internal combustion, as per claim 5, indicated so, that inner-tooth gears (11) off-center mounted relative to rotation axis, are placed in deck-lids (18).

7. Elliptical-rotary motor with internal combustion as per claim 5, indicated so, that inner-tooth gears (11) off-center mounted relative to rotation axis, are located in stator (1).

8. Elliptical-rotary motor with internal combustion as per claim 1, indicated so, that in deck-lid (18) off-center mounted roller bearings (13) carry satellite gears (12).

9. Elliptical-rotary motor with internal combustion as per claim 1, indicated so, that in stator (1) are placed ports (19) for regulating vacuum in intake stroke, ports (24) for flushing and cooling of piston forehead (6), opening for sparkplug (14), intake port for intake of fresh mixture (15), exhaust port for elimination of combustion products (16), and opening for cooling (21).

10. Elliptical-rotary motor with internal combustion as per claim 9, indicated so, that in stator (1) is port (14) for injection of fuel into work cylinder (3).

11. Elliptical-rotary motor with internal combustion as per claim 1, indicated so, that n connected elliptical-rotary motors in rotation axis and phase off-set by the angle of 360/n, constitute one integral whole.
